(19) United States
(12) Patent Application Publication
(10) Pub. No.: US 2005/0206771 A1
(43) Pub. Date: Sep. 22, 2005

(54) Digital video camcorder capable of recording and playing golfing actions

(76) Inventor: Chung-Lung Lin, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/802,792

(22) Filed: Mar. 18, 2004

(51) Int. Cl. H04N 5/222; H04N 5/225

(52) U.S. Cl. 348/333.05; 348/333.01; 348/333.12

(57) ABSTRACT

A digital video camcorder capable of recording and playing golfing actions comprises a lens set, an optical sensor, an image processing module, an image input module, an image display module, a mode select module, a microprocessor, a memory unit and a display unit. After a function of the mode select module is selected, a first image sensed by the optical sensor via the lens set and processed by the image processing module or a second image inputted by the image input module can be recorded into the memory unit. The microprocessor and the image display module can simultaneously display two images already stored in the memory unit on the display unit in a slow-motion, freeze-frame or split-frame way. A touch pen can then be used to directly draw illustration lines on the display unit.

### FIELD OF THE INVENTION

The present invention relates to a digital video camcorder and, more particularly, to a digital video camcorder capable of comparing different golfing actions.

### BACKGROUND OF THE INVENTION

People usually playing golf, regardless of beginners or professionals, care about their golfing actions most. Whether the golfing action is correct not only relates to whether one can acquire a good achievement, but also is a key to scale new heights in the golfing technique. There are many people that play golf often. However, little can find someone to correct one's own golfing action. Therefore, various electronic auxiliary products have been developed. For instance, PGC600R offered by the Caddy Shak Company makes use of a built-in digital video camcorder to record one's golfing actions and analysis software to analyze and compare the golfing actions. However, this product is expensive and bulky, and has complicated functions. It is generally used in a fixed place and exclusively used by professional coaches for teaching analysis. A common golf fan can't afford this product. Existent commercial digital still cameras and digital video camcorders can't provide functions of split-frame comparison, full slow-motion play and image input because they are not designed exclusively for golf.

Accordingly, how to make a low-cost digital video camcorder capable of correcting golfing actions for common golf fans is a problem to be urgently solved in the industry.

### SUMMARY AND OBJECTS OF THE PRESENT INVENTION

The primary object of the present invention is to provide a low-cost digital video camcorder capable of recording and playing golfing actions to play golfing actions of more than one golfer in a slow-motion, freeze-frame or split-frame way. A user can thus check his golfing actions anytime. Moreover, a bulky and too expensive golfing analysis equipment in the prior art can be saved.

Another object of the present invention is to provide an image input module for inputting golfing action images of another golfer into the digital video camcorder.

Another object of the present invention is to provide a digital video camcorder having the split-frame function so that golfing actions of two golfers can be displayed on the same frame.

To achieve the above objects, the present invention provides a digital video camcorder capable of recording and playing golfing actions, which comprises a lens set, an optical sensor, an image processing module, an image input module, an image display module, a mode select module, a microprocessor, a memory unit and a display unit. After a function of the mode select module is selected, a first image sensed by the optical sensor via the lens set and processed by the image processing module or a second image inputted by the image input module can be recorded into the memory unit. The microprocessor and the image display module can simultaneously play two images already stored in the memory unit and display them on the display unit in a slow-motion, freeze-frame or split-frame way. A touch pen can then be used to directly draw illustration lines on the display unit.

The various objects and advantages of the present invention will be more readily understood from the following detailed description when read in conjunction with the appended drawings, in which:

### BRIEF DESCRIPTION OF DRAWINGS

FIG. 1 is a perspective view of the present invention;

FIG. 2 is a circuit block diagram of the present invention; and

FIG. 3 is a disposition diagram of the present invention and peripherals.

### DETAILED DESCRIPTION OF PREFERRED EMBODIMENT

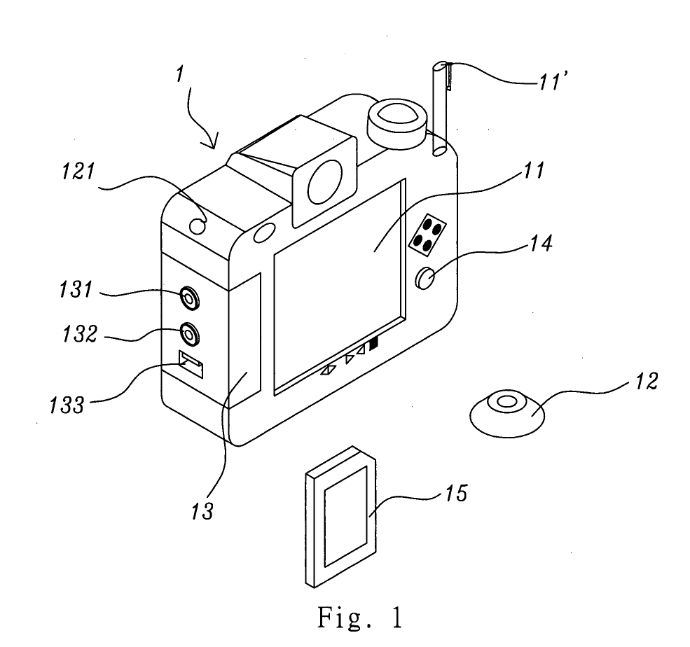

As shown in FIG. 1, a digital video camcorder 1 capable of recording and playing golfing actions has a touch liquid crystal display panel 11, a remote controller 12, an I/O terminal 13, a mode select button 14 and an external memory card 15. The touch liquid crystal display panel is used to display golfing images, a mode select menu, and lines directly drawn by a touch pen 11′. The remote controller 12 is used to remotely activate the shooting function of the digital video camcorder 1. Signals of the remote controller 12 can be transmitted with infrared. A remote control receiver 121 is also provided to receive signals of the remote controller 12. The I/O terminal 13 is used to connect with peripherals. A video output terminal 131 of the I/O terminal 13 is used to output video to a television. The output format is NTSC or PAL. A video input terminal 132 of the I/O terminal 13 is used to input video to the digital video camcorder 1. A universal serial bus (USB) 133 of the I/O terminal 13 is a communication interface between the digital video camcorder 1 and a computer. The mode select button 14 can be used to select the image-playing way including slow-motion play, freeze-frame play, split-frame play and so on. The external memory card 15 is inserted into a memory card slot (not shown) in the digital video camcorder 1, and is made of flash memory for storing the shot image.

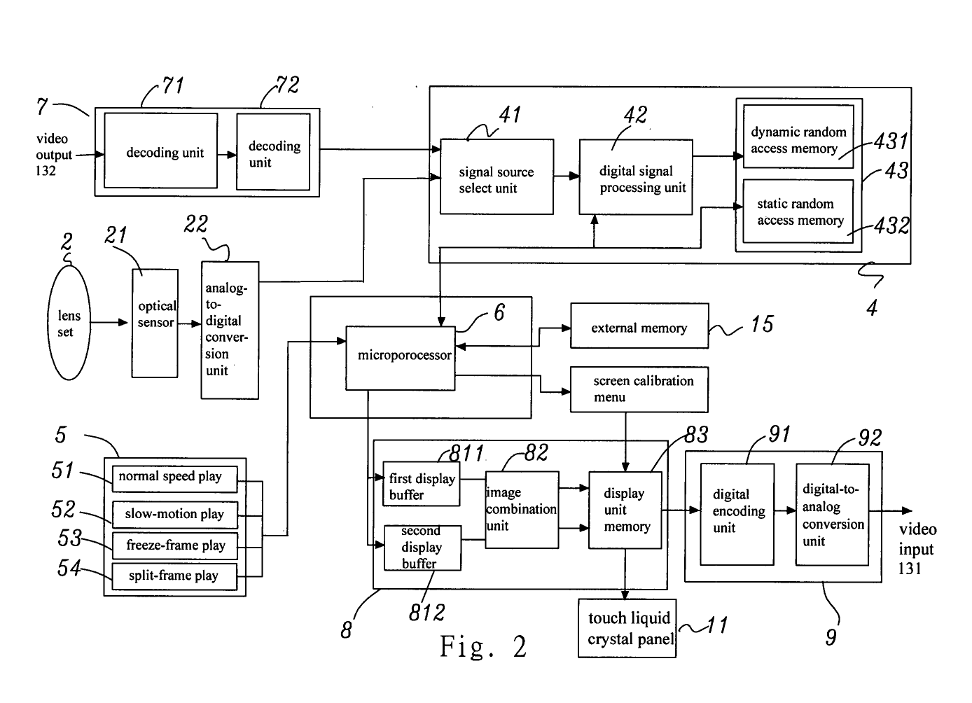

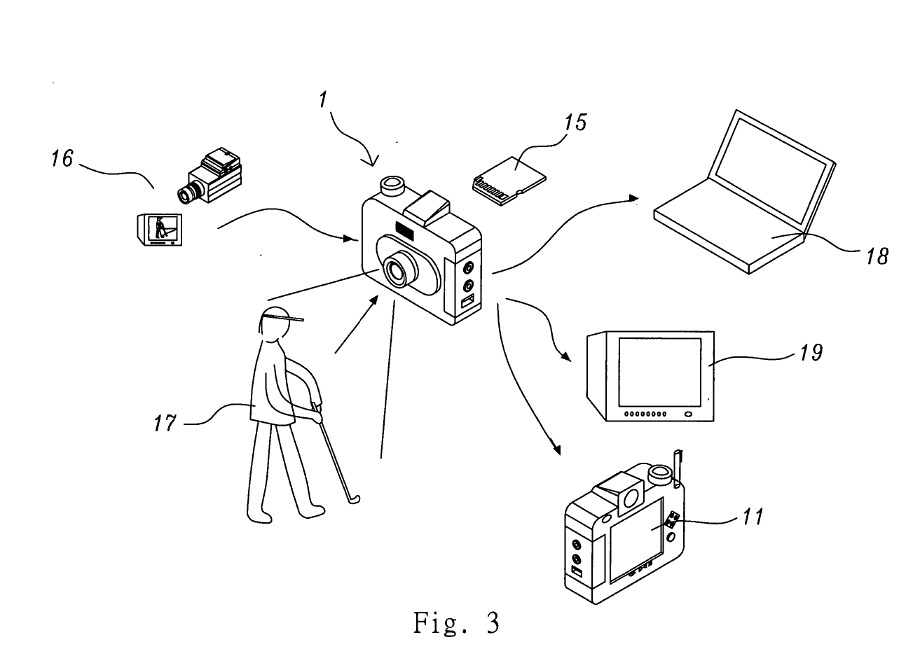

Please refer to FIGS. 2 and 3 at the same time. When the digital video camcorder 1 is used for common shooting function, light 17 from the golfing action of a golfer is focused by a lens set 2 and then impinges onto an optical sensor 21. The optical sensor 21 can be a charge-coupled device (CCD) or a complementary metal oxide semiconductor (CMOS). Analog image signals of the optical sensor 21 are converted into digital signals by a analog-to-digital conversion unit 22. After selected by a signal source select unit 41 in an image processing module 4 and processed by a digital signal processing unit 42, the digital image signals are temporarily stored into a dynamic random access memory (DRAM) 431 or a static random access memory (SRAM) in a memory unit 43. The digital image signals are then stored into the external memory 15.

When a user wants to record an externally inputted video, he first inputs golfing images of another golfer via the video input terminal 132. The golfing images are converted by an analog-to-digital conversion unit 71 and a decoding unit 72 of an image input module 7 into digital image signals. After selected by the signal source select unit 41 and processed by the digital signal processing unit 42, the digital image signals can be temporarily stored into the DRAM 431 or the SRAM 432 in the memory unit 43. The digital image signals are then stored into the external memory 15.

When the user wants to display frames from the digital image signals, he first uses the mode select button 14 to select one of a normal speed play mode 51, a slow motion play mode 52, and a freeze-frame play mode 53 of the mode select module 5. The golfing digital images stored in the memory unit 43 will be first placed in a first display buffer 811 of an image display module 8, stored into the display unit memory 83 through the image combination unit 82, and then outputted to a display. The display can be the liquid crystal display panel 11 of the digital video camcorder 1, a television 19 connected with the video output terminal 131, or a computer 18 connected with the USB 133.

When the user wants to simultaneously play two different images in a split-frame way, he first uses the mode select button 14 to select a split-frame play mode 54 of the mode select module 5, and then selects two images in the memory unit 43 to be played. The two images are stored into the first display buffer 811 and a second display buffer 812 of the image display module 8, respectively, stored into the display unit memory 83 through the image combination unit 82, and then outputted to the display in the split-frame way.

To sum up, the digital video camcorder of the present invention is only used to record and play golfing actions, hence saving an expensive golfing analysis equipment and complex analysis software required in the prior art. If it is necessary to further analyze the golfing actions, the images can be downloaded to a computer for analysis. Moreover, the digital video camcorder of the present invention has a small size so that a golfer can take it for recording his golfing actions anywhere.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A digital video camcorder capable of recording and playing golfing actions comprising a lens set, an optical sensor, an image processing module, an image input module, an image display module, a mode select module, a microprocessor, a memory unit, and a display unit;
whereby after a function of said mode select module is selected, a first image sensed by said optical sensor via said lens set and processed by said image processing module or a second image inputted by said image input module can be recorded into said memory unit, said microprocessor and said image display module can simultaneously play two images already stored in said memory unit and display them on said display unit in a slow-motion, freeze-frame or split-frame way.

2. The digital video camcorder as claimed in claim 1, wherein said image display module further comprises a first display buffer, a second display buffer and an image combination unit.

3. The digital video camcorder as claimed in claim 1, wherein said image processing module further comprises an analog-to-digital conversion unit, a signal source select unit, a digital signal processing unit, and a memory unit.

4. The digital video camcorder as claimed in claim 1, wherein said image input module further comprises an analog-to-digital conversion unit and a decoding unit.

5. The digital video camcorder as claimed in claim 1, wherein said image display module further comprises a digital encoding unit and a digital-to-analog conversion unit.

6. The digital video camcorder as claimed in claim 1, wherein said image display module further comprises a universal serial bus.

7. The digital video camcorder as claimed in claim 1 further comprising a remote control module.

8. The digital video camcorder as claimed in claim 7, wherein said remote control module is an infrared remote control module.

9. The digital video camcorder as claimed in claim 1, wherein said optical sensor is a charge coupled device.

10. The digital video camcorder as claimed in claim 1, wherein said optical sensor is a complementary metal oxide semiconductor.

11. The digital video camcorder as claimed in claim 1, wherein said display unit is a touch liquid crystal display panel.

12. The digital video camcorder as claimed in claim 1, wherein said display unit is a video display unit.

13. The digital video camcorder as claimed in claim 1, wherein said memory unit includes an external memory and a built-in memory.

14. The digital video camcorder as claimed in claim 13, wherein said external memory is a flash memory.

15. The digital video camcorder as claimed in claim 1 further comprising a touch pen for directly drawing illustration lines on said display unit.
